(19) United States
(12) Patent Application Publication
(10) Pub. No.: US 2014/0065593 A1
(43) Pub. Date: Mar. 6, 2014

(54) Automated Assessment and Analysis System

(71) Applicants: John Gannon, New Hope, PA (US); Steven Platt, New Hope, PA (US)

(72) Inventors: John Gannon, New Hope, PA (US); Steven Platt, New Hope, PA (US)

(21) Appl. No.: 14/015,654

(22) Filed: Aug. 30, 2013

Related U.S. Application Data
(60) Provisional application No. 61/694,874, filed on Aug. 30, 2012.

(51) Int. Cl. G09B 3/06

(52) U.S. Cl. CPC G09B 3/06
USPC 434/350

(57) ABSTRACT

The present invention relates to the field of automated evaluation, assessment and analysis. Disclosed is a method to create and store assignments, automatically analyze student accuracy and ability, and store analysis on individual students for an extended amount of time. This method can reduce the time and effort exerted by teachers in the creation and grading of assignments and more effectively analyzes student progress than any known software. An assessment software, “TEACH-TECH,” combined with a web-based database, “Cloud,” in the novel manner disclosed provides a means for substantially increasing the effectiveness of the educational system.

### RELATED APPLICATION

This patent application is a non-provisional of provisional patent application Ser. No. 61/694,874 entitled “Automated Assessment and Analysis System” filed on Aug. 30, 2012, priority from which is hereby claimed.

### FIELD OF THE INVENTION

The present invention relates generally to more efficient method of creating, collecting, assessing, analyzing, and/or storing student work. More specifically, a novel technology (hereafter referred to as “TEACH-TECH”) is able to create, store, and analyze student work. Assignments, answer sheets, student progress, and a range of relevant information is stored on a web-accessible database linked to and incorporating TEACH-TECH technology.

By utilizing TEACH-TECH software in conjunction with digital input technology such as optical character recognition software and a web-based database, teachers are more easily able to create, assign, distribute, collect, evaluate, assess and analyze assignments through methods that will be elaborated on herein.

### BACKGROUND OF THE INVENTION

Currently in educational facilities, the most common method of assessing student performance is through tests, homework, and other assignments. Generally, teachers are expected to manually create, distribute, collect, mark and return these assessments. This manual process involves comparing each completed paper to an “answer key” and marking student answers accordingly. The student's grade is recorded, but seldom is other information noted, and evaluations of student achievement other than a grade are not entered into any system for analysis or later retrieval. This method has several major problems, several of which will be discussed in detail here.

First, the time spent creating and grading each assignment is inefficiently used. After an assignment is created, the creating teacher may store said assignment on his or her personal computer, but there is no mechanism for other teachers to access it. These issues result in multiple teachers each exerting a significant amount of time creating substantially the same assignment. After the assignments are collected, teachers must spend their time analyzing the correctness of every answer on every student submission. This is especially time consuming when answers are written, as in essay assignments, but can be equally frustrating while grading other types of questions. Teachers are often obliged to spend hours of their personal time grading rather than devising methods to more effectively teach their students.

This inefficient time usage contributes to a second problem: the inconsistency of grading. As time passes, mistakes are bound to be made, and teacher fatigue can contribute to either incorrectly scored questions or inadvertently altering criteria of an answer choice. Moreover, variations between teachers can lead to inconsistency of grading from one classroom to another or one school to another. Students also may question whether a teacher's feelings about them influence the assessment of correctness of the homework. The perceived or actual discrepancy in grading can result in a loss of motivation on the part of the student, and a corresponding lack of effort and achievement for said student. The amount of time spent on each assignment is expanded even further by the process of distributing and collecting assignments. Ensuring that each student receives a copy of every paper-based assignment, then collecting each paper by hand, detracts from time in the classroom that could be better spent on instruction. Clearly, a method is needed to reduce the amount of wasted time associated with every worksheet, homework, test, and other assignments.

Perhaps most importantly, there is a significant amount of valuable quantitative information the teacher could elicit from each assignment but is unable to because of the substantial time investment it requires. On any given assignment, the content and difficulty of the various questions differs. A student may demonstrate a clear understanding of one topic on a particular level of difficulty, but struggle as the subject changes and/or the material becomes harder. For example, a student may understand the content of a Shakespearian play but not understand the subtext. Similarly, another student may fully understand the First Act but failed to even read the others. Currently, student achievement is most often measured by an alphanumeric “grade” associated with each assignment, and that grade is generally the only thing that is recorded for each student. Such a grade cannot reflect the nuances of understanding, effort, and achievement previously discussed. Additionally, if a teacher hoped to make note of those various abilities and difficulties of each student rather than simply relying on a grade-based system, that teacher would find their efforts ineffective. While it is conceivable that a teacher may analyze a single assignment thoroughly by spending several days or weeks focusing solely on that assignment, it would become absolutely impossible to sufficiently analyze every homework, worksheet, test, and other assignment submission a student provides. For high school teachers, who tend to have between 100 and 200 students, even minimally analyzing a single assignment each day is prohibitively time consuming. The immediate ramification of this loss of analytical opportunity is that the teacher is unable to effectively help those students who are struggling by not being adequately challenged or excelling against expectations, resulting in more poorly educated students.

A more long term problem from insufficient analysis of student achievement is that communication between parties interested in each student's abilities is significantly limited. A student who is struggling in science may be doing so because of a difficulty in mathematics, but there is no method currently for either the math or science teacher to determine this cause. It is left to one teacher to take it upon himself to elicit feedback from other teachers, a method that is impractical when used for every student. This problem is magnified as a student transfers between grades and/or between schools. A third grade teacher would be greatly helped by knowing a student's abilities as of the end of second grade, but as these abilities are shown only as a letter or percentage grade over the course of the year, the analytical options of that third grade teacher are severely limited. For example, a grade of “B” may mean the student has a relatively good understanding of all topics, that he understands one or more topics very well and others very weakly, or merely that the previous teacher felt his effort was enough to warrant a grade of B. Without significant communication between the two teachers on every single student, there is no way to know what each student truly achieved in previous years. Currently, states are attempting to address this problem by providing standardized tests that students take at specific intervals during their education, but there is substantial debate over the ability of these tests to measure student understanding and achievement. Moreover, even if it was decided that these tests were accurate, their results are poorly descriptive; what does “average math skills” mean, practically?

There have been several inventions aimed at solving one or more of the aforementioned problems, though none have sufficiently overcome them. In US 2006/0194189A1, an apparatus to scan and mark an assignment's answers as correct or incorrect is claimed, yet the teacher is still required to expend time creating, distributing, and collecting said assignment. There is also no mechanism to analyze or store student abilities other than a percent-correct determination. US 2006/0257841A1 seeks to help the teacher with the collection portion of this manual method by providing a portable “teacher unit,” but leaves the other issues unresolved. Additionally, the majority of automated graders are limited to the assessment of multiple choice tests. This excludes assessments other than tests while creating the additional problem of limiting the answers to a correct/incorrect format. In order to attain an accurate assessment of each student's abilities, teachers must have the ability to utilize assignments that are not simply multiple choice or true/false, but include some form of essay or short answer.

In light of these and additional problems associated with assessing students, there is a great need in the art for a method to quickly and efficiently create and grade assignments, analyze assignments, and record and store student progress and achievement throughout the course of their educational career, and perhaps into their professional career. The invention disclosed seeks to provide a means to accomplish each of these things.

### SUMMARY OF THE INVENTION

To satisfy the aforementioned needs, the present invention utilizes a method for and system of automated assessment and analysis. A teacher or similar educational professional (hereafter referred to as “teacher”) is able to access a system with two primary components: a grading and assessment component, and a storage component.

First, said system has a program accessible by any participating teacher that allows said teacher to create and save assignments through the use of an assignment “Wizard,” designed to easily guide teachers through the creation of both assignments and answer sets. This same program will then be able to assess the assignment after students have completed it, evaluating each student's accuracy on the assignment and his or her various strengths and weaknesses within the assignment. As the teacher creates the assignment, he may indicate information about each question, including difficulty, content, question type, and/or point value. Though the system can easily provide a standard “grade” as defined above, a more thorough evaluation of each student is readily accessible utilizing the teacher-input information. This evaluation will allow teachers to determine if there is a particular area in which each student particularly struggles, thus fostering a more appropriate remedial, growth-promoting learning environment.

The second primary component of said system is a database that stores two broad areas of data. One set of data includes assignments created by any teacher with access to the system and stored indefinitely, allowing other teachers to access said assignments. The assignments are stored with their corresponding answer set, and though both the assignment and answer set are alterable by any teacher who wishes to use them, they are able to be downloaded and used with little to no changes by any teacher. Assignments can be organized in any logical way, including by grade, by content, or by type. A feature is that the storage of assignments is not limited to assignments created via the system mentioned above, but any assignment created in any way may be uploaded and stored on the database. The second set of data is a recording of student performance. As student work is submitted for analysis via the system discussed above, the assignment answers are analyzed thoroughly for accuracy, completeness and other criteria desired and the results of said analysis are stored indefinitely for each participating student. As such, there will be an accurate recording of each student's progression over time. As each student will be identified in a unique manner, i.e. with a personal identification number (“PIN”), the student's data may be accessible independently and securely by any relevant party, including teachers, administrators, parents, and the student himself.

Combining a system of creating and assessing assignments with a database to store both assignments and student data is unknown in the art and would have significant advantages already discussed. Teachers would be able to spend significantly less time on each assignment, yet amass more detailed and complete information on each student than previously possible. This system will enable teachers to guide their lessons and students far more effectively, resulting in an overall better education process.

### BRIEF DESCRIPTION OF THE DRAWINGS

FIG. 1 is a flow chart illustrating multiple embodiments of the present invention.

FIG. 2 is a flow chart illustrating one embodiment of the present invention

### DETAILED DESCRIPTION OF THE INVENTION

The foregoing and other objects, features, and advantages of the invention will be more apparent from the more detailed description of the preferred embodiments, as illustrated in the accompanying drawings. The drawings are intended to illustrate the principles of the invention, not necessarily to limit the invention to one of these particular embodiments.

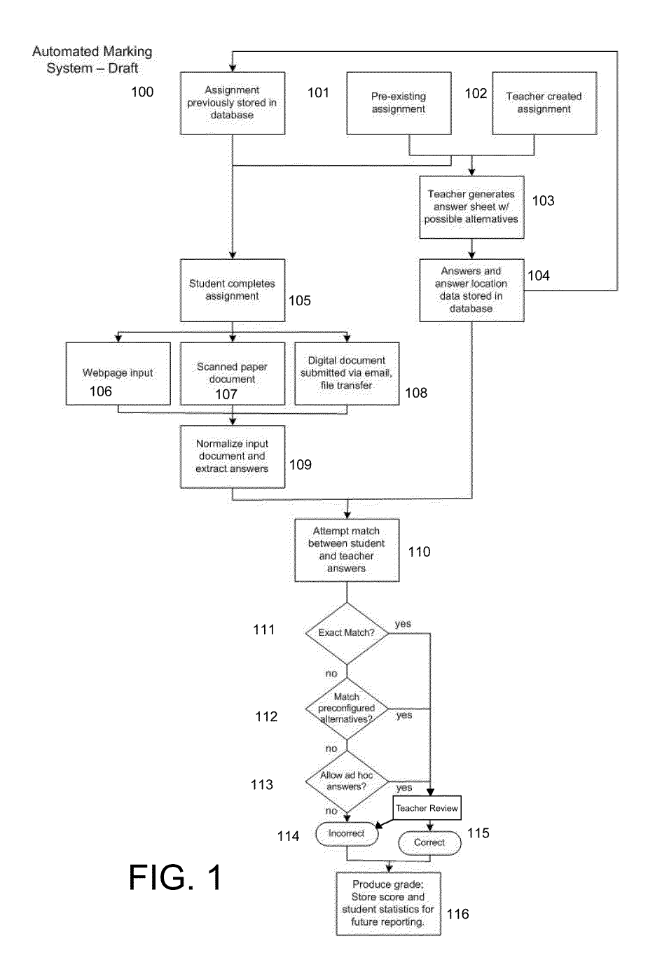

FIG. 1 illustrates the method of the automated grading system in several possible embodiments. Assignment 100 represents one potential method for acquiring an assignment, namely, retrieving a previously created assignment from a database. Assignments 101 and 102 represent two alternative methods for acquiring an assignment, 101 being modification of a pre-existing assignment, and 102 being creation of a wholly new assignment. Via either method 101 or 102, an answer set is created 103 and stored in the grading software database 104. Once the answer set is in the database, regardless of which method used, the student must then complete the assignment 105. In one example embodiment of the invention, either the student or teacher has the option to submit the assignment to the grading software by one of: the student directly inputting answers on the grading software 106, which may use character recognition technology such as OCR (“optical character recognition”) or ICR (“intelligent character recognition”) converting a non-digital set of answers into digital format 107, or transfer of a digital document into the grading software via email, file transfer, or a variety of other means well known in the art 108. The inputted answers must be normalized to a format comparable to the teacher answer set 109, then the teacher and student answers are compared 110. If, for any given question, the student and teacher answers are an exact match (complete similarity) 111, the answer is marked as correct 115, and the analysis for that question is completed. If the two are not an exact match, the analysis for that question continues. If the student answer matches or is similar to one of the predetermined alternatives 112, the answer is marked as correct 115 or partially correct and the analysis of that question is completed. If the student answer does not match and has no similarity to any of the alternatives, analysis continues. If the teacher has opted to allow ad hoc answers 113, the question may be marked for further review. If the teacher has not opted to allow ad hoc answers for that question, the question is marked incorrect 114. After this process has completed for every question, the grading software produces a grade and analysis and stores both in a database 116 for future retrieval.

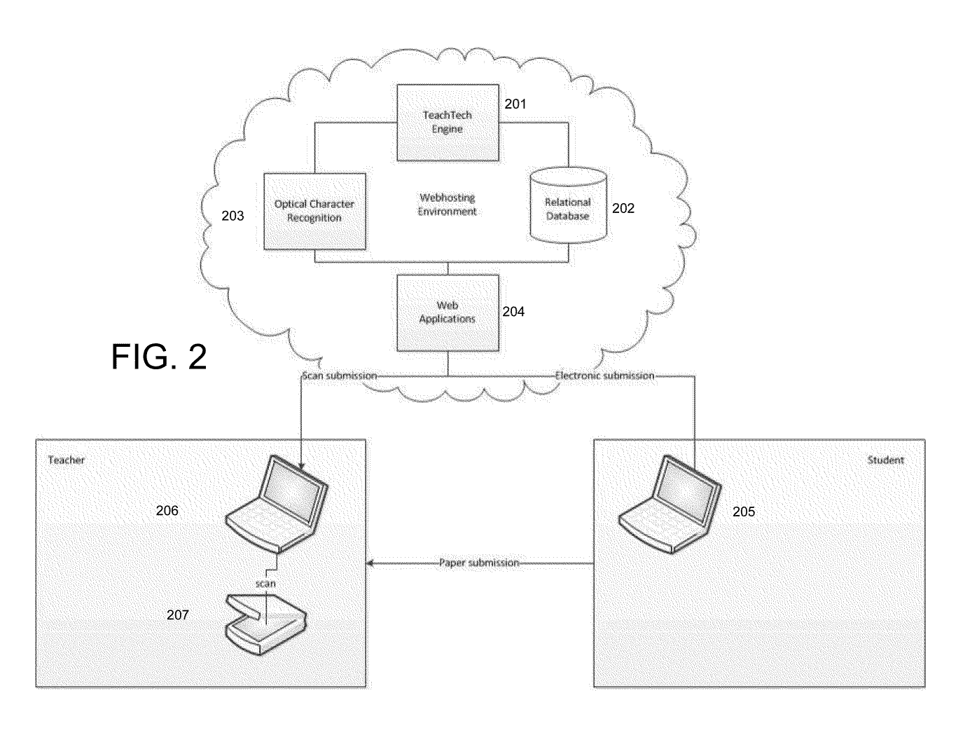

FIG. 2 illustrates one embodiment of the invention. The relationship of each component of the automated grading system in this embodiment is represented. The webhosting environment consists of the TEACH-TECH engine 201, optical character recognition technology 203, a relational database 202, and web applications to facilitate the process 204. This environment will store the assignments and student analysis and perform the process of automated grading. In order to access this environment, two possibilities are shown. The student may complete the assignment on paper which will then be transferred into digital format, in this case via scanning 207. The teacher will then electronically submit the papers to be graded to the webhosting environment 206. Alternatively, the student may submit the completed assignment electronically using a computer 205.

An embodiment of the present invention utilizes a method for and system of automated assessment and analysis. The automated assessment and analysis system incorporates character recognition software 203, an assessment and analysis system 201, a web-based database 202, and a means to convert information into digital information 204 to more efficiently monitor student academic achievement at individual, classroom, school, district, state, national and international level. The various components may be permanently connected to each other or connected on an as-needed basis. However, each component interacts with the others in a manner that will be discussed herein.

One embodiment of the invention, hereafter referred to as “TEACH-TECH”, includes a novel grading system designed to allow teachers to have more analytical powers while simultaneously reducing their preparation time. TEACH-TECH is a system that allows teachers to create or modify assignments, store said assignments for future retrieval, submit completed assignments for automated grading, and store data about students to aid in further analysis of said students' academic abilities. Each aspect stated above will be discussed in detail.

In this embodiment, teachers will have the ability to create assignments and answer sets utilizing an assignment creation “wizard.” Said wizard is a system that will guide teachers through the creation of each question and answer providing an easy way to use preset criteria such as question type, point value for each question, and multiple acceptable or partially acceptable answers, for example with a math assignment, including each separate digit as a potential part of the answer. As the teacher creates the assignment, the wizard will allow teachers to indicate relevant information about each question, such as content, difficulty, or various other notes. These values can be used during the assessment process to identify and document the subject areas in which students require additional help or to show mastery of the subject. After the creation of an assignment utilizing the TEACH-TECH wizard, the assignment and answer set will be stored on a web-based database to allow future access and/or access by others. The teacher will indicate data about the assignment as a whole, such as topic, grade level, and/or difficulty. This classification will be used to organize the database as assignments are entered. Alternatively, a teacher may create an assignment independent of the TEACH-TECH wizard, subsequently entering the assignment, answer set, and relevant data into said web-based database.

After the selection of an assignment, teachers are able to distribute said assignment in a variety of ways. TEACH-TECH allows students to log onto the system using a personal identification number (PIN) or other authentication system. Said students can then access assignments identified by the teacher and either print them and complete them by hand or complete them directly online. TEACH-TECH also provides the option for teachers to print out assignments and distribute them physically. Regardless of the distribution method, students can input their answers into TEACH-TECH software, or return said answers to the teacher. If the latter is chosen, the teacher can then input each student's answers into TEACH-TECH through a variety of methods, the most convenient of which may be to scan each answer sheet into digital format. The answers will be analyzed using character recognition technology such as OCR or ICR, which is well known in the art, to compare each answer sheet to the teacher-made answer set for the assignment. This answer analysis can take on a variety of forms, several of which will be discussed.

First, TEACH-TECH can run a simple analysis of marking each question for each student, based on accuracy of answer, and determining an appropriate assessment resulting in a numerical grade based on the accumulated points. Teachers also may indicate a particular question or type of answer that requires human evaluation prior to determination of a grade. One novel feature, however, of TEACH-TECH in this embodiment is the ability to perform a more-thorough assessment of each student than was previously possible. Utilizing the information about each question provided by the teacher, TEACH-TECH can run a thorough analysis for each assignment. Rather than simply noting the overall grade of the assignment, which is the standard practice in the art, TEACH-TECH can indicate and record student answer accuracy, i.e., how each student did, on each type of question. This feature allows teachers to find each student's strengths and weaknesses and give every student the appropriate type of help. It also enables teachers to see if there are common difficulties among the whole class, which would suggest an area that needs to be re-taught. By utilizing this feature of TEACH-TECH, teachers will be able to significantly enhance the effectiveness of their assessments, and therefore their lessons. This benefit is apparent even if utilizing this technology for a single assignment, but the incorporation of a web-based database expands the potential usefulness exponentially.

TEACH-TECH is linked to and communicates with a proprietary web-based database of the invention, enabling the analysis of each student across a wide range of assignments. After analyzing student answer accuracy on each assignment, TEACH-TECH will store said analysis of each student on the web-based database. This process is repeated for each subsequent assignment. As additional assignments are submitted, TEACH-TECH can compare each student's progress with regard to topic, difficulty, and accuracy level. Through the TEACH-TECH system and its web-based database, an unbiased, continuous analysis of student progress will be recorded and stored for access by the student, parents, teacher or others. The benefits of this resource are incalculable. Teachers will be able to better assess their students, aid them in the areas they need help, indicate what their strengths are, coordinate study and research groups, and better facilitate countless activities. Moreover, the web-based database of the invention can be accessible by all teachers, following students as they progress academically, so new teachers will have access to an accurate analysis of each of their students from the first day of school, based on previous student work.

The range of people who can be provided with access to the web-based database of the invention further enhances the benefits of this long-term student database. Administrators can more accurately assess teacher performance by monitoring the change in student aptitude over time. Currently, standardized tests are the only mechanism to evaluate teaching ability using student performance. A classroom with generally lower-performing students however may reflect factors other than lower-performing teachers. For example, if a student enters a fifth grade classroom on a second grade reading level, it is very difficult for that student's fifth grade teacher to raise that student to an “appropriate” level in the eyes of school administrators. The current expectation is that by the end of the year, that student and all other students in the classroom will be able to read on a fifth grade level. If that teacher manages to raise said student to a fourth grade reading level, the teacher should be applauded, but standardized tests are unable to identify this accomplishment. With TEACH-TECH, the level of each student in every subject can be known at the start and end of every year, as well as after every submitted assignment. Administrators will finally have a mechanism to determine the impact of the teacher on each student. Additionally, parents and students can monitor the student's progress so that students are able to recognize their accomplishments and parents are able to provide the most effective at-home help. Currently, both parents and students are reliant on communication from the teacher for this data, which at best is less thorough than TEACH-TECH and at worse is infrequent and vague. TEACH-TECH provides a significant improvement on the state of the art with regard to analysis of academic achievement.

The web-based database of the invention also provides a novel advantage in the creation of assignments. As previously disclosed, teachers may create and/or upload their assignments onto the web-based database of the invention. The assignments can be classified based on content, grade level, difficulty or other attributes and can be stored indefinitely, accessible to any teacher who interfaces with this system. Thus, teachers can choose from a variety of appropriate assignments and pick one best suited for their classrooms. Teachers will be able to save time by not creating an assignment from scratch and to obtain ideas for assignments or questions that may be better in some respects than could be created by a single teacher working alone. Moreover, said assignments and answer sets can be modified, allowing teachers the flexibility to tailor assignments to fit the requirements of each unique classroom or even individual students in the classroom.

In one embodiment, TEACH-TECH is a system that allows users to create, analyze, store, and retrieve assignments. Though several of the benefits of said software and web-based database have been discussed at length here, a person skilled in the art would recognize that the benefits are not limited to those disclosed. The present invention includes any automated assessment and analysis software with the ability to create assignments, analyze assignments, and store said analysis for any amount of time.

In one preferred embodiment, TEACH-TECH is embedded with optical character recognition software. This allows the user to access the program from a predetermined computer or set of predetermined computers that are modified to contain both required softwares.

In a second embodiment, TEACH-TECH is accessible via the web-based database of the invention or a similar web-based portal. The benefit of this feature is that the user can access TEACH-TECH from any computer by remotely utilizing a computer with the required components. This would allow teachers to create assignments using the TEACH-TECH wizard without having to be tied to a particular location.

In a third embodiment, TEACH-TECH is downloaded onto a particular computer via a removable media device such as a compact disc. The user would then be able to connect that computer to the web-based database of the invention in order to access the benefits of the online database.

A person skilled in the art will recognize there are a multitude of other ways to access software of this type, and that these examples are meant to exemplify a few options, not limit the method in which the grading software is utilized.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method of computer grading of an assignment comprising the steps of:
selection of an assignment and answer set;
distribution of said assignment to one or more students; and
submission of completed assignment to grading software, said software subsequently analyzing said assignment and storing of results of analysis.

2. The method of claim 1 wherein grading software uses character recognition technology.

3. The method of claim 1 wherein grading software is accessed from a web-based database.

4. The method of claim 1 wherein grading software is installed on a particular computer or set of computers.

5. The method of claim 1 wherein selection of an assignment occurs by creation of a new assignment and answer set.

6. The method of claim 6 wherein creation of said assignment and answer set occurs on a web-based database portal.

7. The method of claim 7 wherein creation of assignment is facilitated by an assignment creation “wizard.”

8. The method of claim 1 wherein selection of an assignment occurs by selecting a previously made assignment.

9. The method of claim 9 wherein previously made assignment is located on a web-based database.

10. The method of claim 9 wherein previously made assignment and answer set is modified from a previously created assignment and answer set.

11. The method of claim 1 wherein the answer set is incorporated into the grading software to allow automated grading.

12. The method of claim 1 wherein said answer set includes indications that each answer is “correct,” “incorrect,” or “partially correct.”

13. The method of claim 1 wherein said answer set has an option to allow a human analyst to view and mark a particular answer or set of answers.

14. The method of claim 1 wherein points are assigned for correct or partially correct answers on said assignment.

15. The method of claim 1 wherein a creator of the assignment indicates how wrong answers will be marked.

16. The method of claim 1 wherein distribution of assignments occurs digitally.

17. The method of claim 1 wherein distribution of assignments occurs via a paper-based format.

18. The method of claim 18 wherein completed assignments are transformed into digital format.

19. The method of claim 1 wherein completed assignments are transformed into a format comparable to the answer set.

20. The method of claim 1 wherein completed assignments are submitted to the grading software by the students.

21. The method of claim 21 wherein students are identified by a personal identification number and password.

22. The method of claim 1 wherein the teacher collects the completed assignments and submits them into the grading software.

23. The method of claim 1 wherein the grading software analyzes the assignment via comparison to the answer set.

24. The method of claim 1 wherein analysis of assignment consists of indicating the accuracy of an answer on the completed assignment.

25. The method of claim 1 wherein analysis of assignment consists of providing an overall score or “grade.”

26. The method of claim 1 wherein analysis of assignment consists of evaluating students based on a particular attribute.

27. The method of claim 27 wherein said attribute is accuracy of student's answers on an assignment.

28. The method of claim 27 wherein said attribute is similarity of incorrect answers.

29. The method of claim 27 wherein said attribute is student progress over time.

30. The method of claim 1 wherein analysis consists of prediction of student achievement on future assignments.

31. The method of claim 1 wherein a subset of answers is indicated for review.

32. The method of claim 32 wherein said subset is determined by indicating a particular percentage of students who answered incorrectly.

33. The method of claim 32 wherein said subset is determined by indicating a particular incorrect answer type.

34. The method of claim 1 wherein students may access their assignments and results via utilization of a personal identification number (PIN).

35. The method of claim 1 wherein teachers may access the assignment's analysis for each student.

36. The method of claim 1 wherein school administrators may access analysis for classrooms.

37. The method of claim 1 wherein parents may access the analysis on their student.

38. The method of claim 1 wherein post-secondary education facilities may access a particular student's records.

39. The method of claim 1 wherein employers or potential employers of students may access a particular student's records.

40. The method of claim 1 wherein a created or modified assignment is stored in a web-based database to enable future use.

41. The method of claim 41 wherein said assignments are organized by subject, grade level, or another relevant feature.

42. The method of claim 41 wherein said assignments and answer sheets may be modified.

43. The method of claim 1 wherein data is stored on individual students for an indefinite amount of time.

44. The method of claim 1 wherein data is stored on individual students for a predetermined amount of time.

45. An article of manufacture, comprising a machine-accessible medium having instructions encoded thereon for enabling a processor to perform the operations of
a. Creation, selection or modification of an assignment;
b. Analysis of completed assignment; and
c. Submission of assignment to a database.

46. An article of manufacture, comprising a machine-accessible medium having instructions encoded thereon for enabling a processor to perform the operations of
a. Accessing the database of the invention;
b. Searching or browsing information on said database per the metrics about the assignments, students, teachers and classes; and
c. Receiving information from said database in the form of data collected and analyzed per the metrics about the assignments, students, teachers and classes.
